(19) United States
(12) Patent Application Publication
(10) Pub. No.: US 2010/0174920 A1
(43) Pub. Date: Jul. 8, 2010

(54) DATA PROCESSING APPARATUS

(76) Inventors: Jonathan Peter Buckingham, Bristol (GB); Andrew Hana, Bristol (GB)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/349,007

(22) Filed: Jan. 6, 2009

(51) Int. Cl. G06F 12/14

(52) U.S. Cl. 713/193; 711/163; 711/E12.092; 711/103; 711/104

(57) ABSTRACT

A data processing apparatus comprises an integrated circuit containing a data processor and a non-volatile store storing at least one security code. A first memory external to the integrated circuit stores data, the data being cryptographically protected in a first format. A second memory external to the integrated circuit is provided for storing data. The apparatus is arranged to transfer data from the first memory via the integrated circuit to the second memory to be accessed by the data processor from the second memory. The integrated circuit is arranged to validate during the transfer the data read from the first memory using a security code stored in the non-volatile store. If the data is validated, cryptographic protection is applied in a second format to the validated data using a security code stored in the non-volatile store. The protected data is stored in the second memory in the second format.

### FIELD OF THE INVENTION

The present invention relates to a data processing apparatus.

### BACKGROUND OF THE INVENTION

It is known to provide an integrated circuit containing, amongst other features, a data processor. In some applications it is necessary to ensure the data, including executable code, being processed cannot be changed by unauthorised people accessing data stored outside the integrated circuit or if it is so accessed ensuring it cannot be changed undetectably.

### SUMMARY OF THE INVENTION

In accordance with one aspect of the present invention, there is provided an apparatus comprising: an integrated circuit containing a data processor and a non-volatile store storing at least one security code; a first memory external to the integrated circuit storing data, the data being cryptographically protected in a first format; and a second memory external to the integrated circuit for storing data; the apparatus being arranged to transfer data from the first memory via the integrated circuit to the second memory to be accessed by the data processor from the second memory; the integrated circuit being arranged to validate during the transfer the data read from the first memory using a security code stored in the non-volatile store and, if the data is validated, apply cryptographic protection in a second format to the validated data using a security code stored in the non-volatile store, and store in the second memory the data protected in the second format.

By transferring data via the integrated circuit and using the integrated circuit to validate data and protect transferred data, security is maintained because the validation occurs, and protection is applied, within the integrated circuit.

By cryptographically protecting the data in the first memory and in the second memory, based on a security code(s) in the non-volatile store in the integrated circuit, the data is made secure.

In an embodiment, only validated data from the first memory is processed and when data is read from the second memory by the data processor only validated data from the second memory is processed.

In an embodiment, the second memory is a Random Access memory (RAM) for the data processor allowing the data processor to store and to retrieve individual words, which are individually protected as contrasted with the first memory, which is a Read Only Memory (ROM) and which allows read only access only to a data set.

The invention also provides a data processing apparatus comprising:
a integrated circuit having a data processor, a non-volatile store storing at least one security code, a hash calculator and an interface at the boundary of the integrated circuit; and
a memory external to the integrated circuit for storing data for use by the processor,
the memory being coupled to the data processor via the interface at the boundary of the integrated circuit to receive words from the data processor and to provide words to the data processor,
the data processor and hash calculator being arranged to
a) calculate for each word a hash function dependent on a security code stored in the said non-volatile store and store the hash in association with the word,
b) retrieve from the memory stored words, recalculate a hash function for each retrieved word using the security code, and compare the recalculated hash with the stored hash, and
c) allow the retrieved word to be processed by the data processor only if the recalculated and stored hashes have a predetermined relationship.

Embodiments of the invention will now be described, by way of example, with reference to the accompanying drawings.

### BRIEF DESCRIPTION OF THE DRAWINGS

FIG. 1 is a schematic block diagram of a data processing apparatus in combination with a controlled system;

FIG. 2 is a schematic block diagram of a circuit for disabling a test interface of the apparatus of FIG. 1;

FIG. 3 is a diagram illustrating checking of digital signatures; and

FIG. 4 is a flow diagram illustrating use of HASH functions in storing and retrieving data from a DRAM of the apparatus of FIG. 1.

### DETAILED DESCRIPTION OF EMBODIMENTS OF THE INVENTION

In this example the data processing apparatus is a microcontroller 2 for controlling a controlled system 26.

The following description initially describes the configuration of the microcontroller 2 and the contents of its various stores and memories as it would be used after manufacture.

Microcontroller 2 is coupled to a controlled system 26 via a port 3. The controlled system may for example be a back-up tape drive. In the case of a back-up tape drive it is important that the integrity of the backed up data is maintained. It is thus important that the integrity of the data and programs used by the microcontroller is maintained.

The microcontroller comprises a printed circuit board PCB 2 which comprises an ASIC (Application Specific Integrated Circuit) 4, a non-volatile memory 6 and a Random Access Memory 8. The non-volatile memory 6 may be any suitable type for example a Flash memory amongst other types. In this example it is a Read Only Memory, for example an EEPROM. The Random Access Memory 8 may be any suitable memory, for example an SRAM, but in this case it is a DRAM. The non-volatile memory 6 and the random access memory 8 are external to the ASIC 4. A further non-volatile memory 30 may optionally be provided on the PCB external to the ASIC and coupled to it via an interface 301.

The ASIC is a monolithic integrated circuit comprising: one or more processors 10-1, 10-2: tightly coupled memory 14 which may be an SRAM: a non-volatile boot ROM 16 containing code which is not modifiable; a hashing engine 18; one or more One Time Programmable (OTP) memories 20 and 22; a test port 12; an interface 32; interfaces 63, 81 and 301 coupled to the external memories 6, 8 and 30; a random number generator 28; and a hardwired test disabling circuit 24. The OTP memories 20 and 22 may be separate memories or sections of one memory. In this example they are sections of one memory. The test disabling circuit 24 is interposed between the test port 12, which in this example is a JTAG port, and the processor(s) 10. The disabling circuit 24 is responsive to data in the OTP memory section 22. The hashing engine 18 uses data (one or more keys) in the OTP memory section 20. The OTP memory section 20 stores critical security parameters (CSPs) including a secret key and at least one Public Key. Other keys may be filed in the OTP memory section 20. The secret key is unique to each instance of the microcontroller in one implementation of the invention.

The processor(s) 10 execute(s) instructions only from the tightly coupled memory 14 and from the DRAM 8. The boundary of the ASIC is a cryptographic boundary and data and program execution within it are regarded as secure as will be explained below. The EEPROM 6 and the DRAM 8 (and memory 30 if provided) are outside the cryptographic boundary and in the absence of security measures the contents of them would not be secure. The interfaces 12, 63, 301, 32 and 81 are at the physical and cryptographic boundary of the ASIC.

The contents of the DRAM 8 and EEPROM 6 are cryptographically protected by authentication codes. In this example the authentication codes used in the DRAM are of a different type to those used in the EEPROM. In this example, the content of the EEPROM 6 is made secure from undetected malicious modification at least by use of digital signatures. Also, the format of the data in the EEPROM is different from that in the DRAM.

The EEPROM 6 stores firmware which is arranged in one or more data sets 61 each with a digital signature 62. The digital signatures used in this example of the invention use public and private keys. Thus the details of the digital signatures will not be further described because they are within the knowledge of those skilled in the relevant art. When a data set is read from the EEPROM 6 its digital signature is checked by the processor(s) 10 and, if valid, the data set is processed by the processor(s) 10. The processor(s) 10 execute only validly signed firmware.

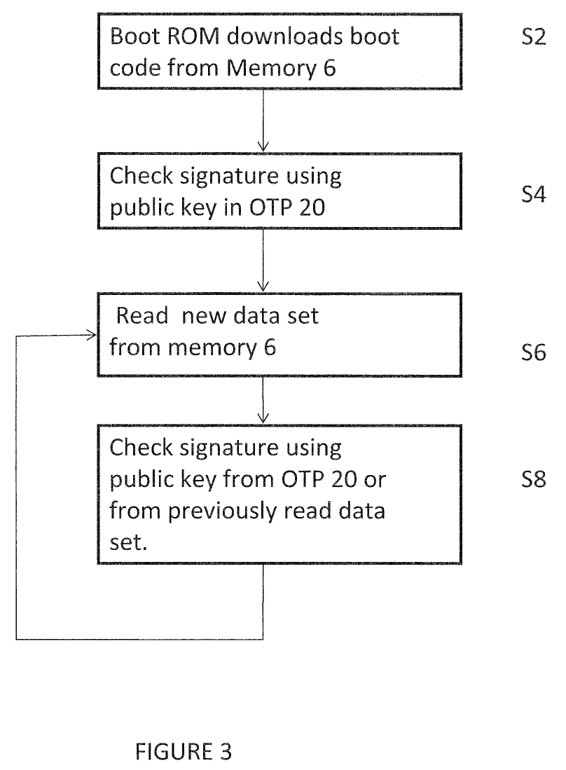

Referring to FIG. 3, in one example, the boot ROM 16 contains code which is used to read S2 a loader program from the EEPROM 6 to read further data sets from the EEPROM. A program counter (not shown) in the processor 10 is loaded with the start address of the boot ROM 15. The processor then executes the code in the boot ROM. That code may read a loader program from the EEPROM 6. The boot code within the boot ROM is deemed secure because it is within the cryptographic boundary. The loader program is protected by a digital signature which the boot ROM code checks S4 using the public key stored in the OTP 20. Subsequent data sets are read S6 using the loader program. The loader program and the subsequent sets have respective digital signatures and have one or more public keys embedded in them. The loader code checks S8 the signature of data set newly read from the EEPROM 6 using a public key embedded in a previously loaded data set or stored in the OTP memory 20.

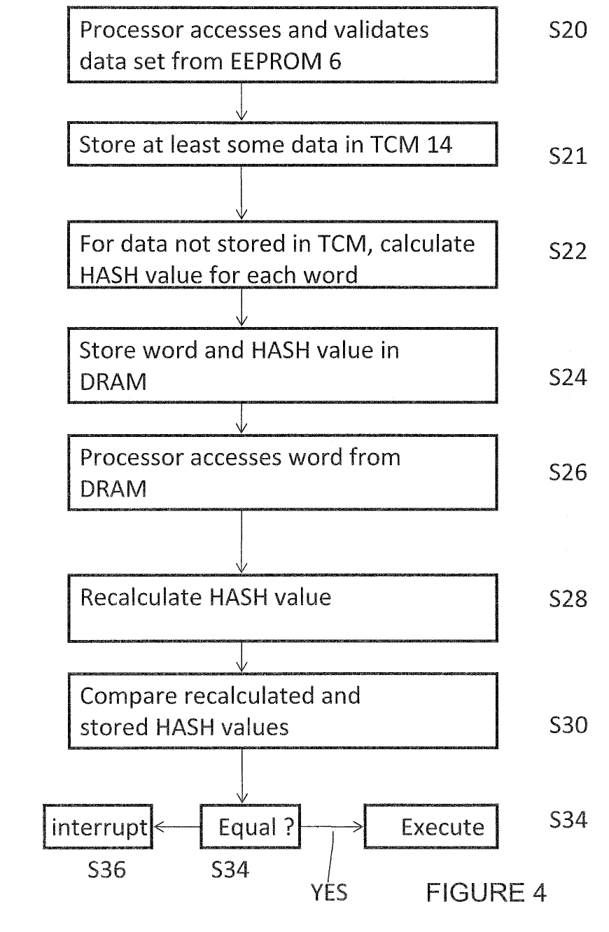

A data set read from the EEPROM 6 may contain too much code/data of the firmware for the small amount of tightly coupled memory TCM 14 on the ASIC to store. The TCM 14 stores firmware code/data needed immediately by the processor(s) 10 and the remainder of the firmware data set is transferred to the DRAM 8. Because the DRAM 8 is outside the cryptographic boundary, the code/data stored in it is cryptographically protected by authentication codes. Referring to FIG. 4, data is read as a data set from the EEPROM 6, and is written to, and read from, the DRAM 8 as words. In this example, when a data set is read from the EEPROM S20, it is validated as described with reference to FIG. 3. At least some of the data of the set is stored in the TCM 14 in step S21. The remaining data of the set is processed and stored in the DRAM 8 as follows. The processor(s) 10 operate with the hashing engine 18 to calculate S22, for each word of the remaining data, a hash value and store S24 the hash value in the DRAM at a location associated with the stored word. Word size is chosen to suit system constraints. It could be as small as one byte. In practice it may be 32 bits. When a word is read S26 from the DRAM 8 the processor 10 and the hashing engine recalculate the hash and compare S30 the recalculated hash with the corresponding hash value stored in the DRAM. If the hash values have a predetermined relationship S34, e.g. they are equal, the read data is processed S38 by the processor(s) 10. If they do not have the predetermined relationship then processing is interrupted S36 and/or an error message generated and/or the data/code ignored.

Storing words in the DRAM with respective authentication codes facilitates random access to the words by the processor(s) 10.

The hash function may be any suitable hash function. An example is the well known HMAC function. In this example, the HASH function uses the secret key stored in the OTP memory 20. It could use another key stored in the OTP memory. An example of the hash value is HMAC(addresslldatallsecret key) where 11 indicates concatenation. The HASH value has at least sufficient bits, taking account of the number of bytes the DRAM can store, to avoid, or at least reduce the chance of, duplication of HASH values within the DRAM. The number of bits of the HASH value may be at least 96 bits and may be much larger. The industry standard is 160 bits which reduces the likelihood of duplications of hash values to a sufficiently low level.

Providing the cryptographic boundary and protecting data stored in the DRAM 8 and EEPROM 6, protects the microcontroller from unauthorised access to the programs and data used by the processor(s) in normal operation. However, the JTAG test port could provide access to the processor(s) 10 in a test mode using known EMULATE and TRACE routines and allow program changes to be made. The JTAG test port is needed for testing at least during manufacture and may be used to diagnose faults after manufacture.

To prevent unauthorised use of the test port, the OTP memory 22 contains at least one security bit which, with the disabling circuit, 24 disables the port 12.

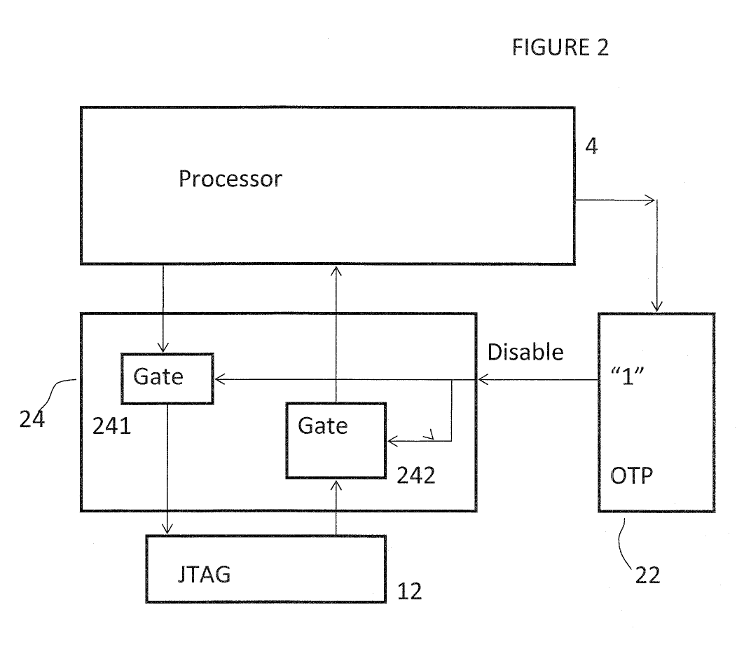

In one example the OTP memory 22 contains only one bit. The OTP memory 22 allows a bit to be changed only once from one state e.g. “0” to the opposite state “1”. During manufacture of the microcontroller the bit is “0” allowing testing and the bit is set to “1” before the microcontroller is released for use. Referring to FIG. 2 the JTAG port 12 has a serial input and a serial output. The disabling circuit, which is part of the integrated circuit ASIC, has a gate 241 interposed between the serial output and the processor(s) 10 and a gate 242 interposed between the serial input and the processor(s) 10. The security bit “1” in the OTP disables the gates 241 and 242. Because the security bit is not changeable the test port is secured against use after manufacture of the microcontroller.

In another example, OTP memory 22 has a two bit security code, which is initially “00”. That allows testing during manufacture, after which the code is set to “01”, i.e. one of the two bits is set to “1”. That code “01” disables the gates 241 and 242. If a fault occurs, then the microcontroller is returned to the manufacturer who sets the other bit to “1” resulting in code “11” which allows testing via the port 12. Access to the OTP memory 22 to change the security code can be provided by suitable access code signed with a digital signature which can be verified by a key stored in the OTP memory 20. The key is for example the default public key stored in the memory 20. That allows the security code to be changed to “11” allowing testing via the port 12. The original microcontroller is retained by the manufacturer and the user receives a new microcontroller.

In a further example, the security code may have three or more bits changeable with use of the signed access code. During manufacture, the code is “000” and when released to a user is “001”. If a fault occurs the code is changed to “011” by the manufacturer to allow testing. After testing the code is changed to “111”, securing the port 12 against use, allowing the microcontroller to be returned to the user. Only signed access code, signed with a digital signature which is verified by a key held in the OTP memory 20 can be used to change the code stored in the OTP memory 22.

Security codes of two or more bits provide an audit trail of testing (or any unauthorised attempts at testing) after manufacture.

### Further Interface and Further EEPROM

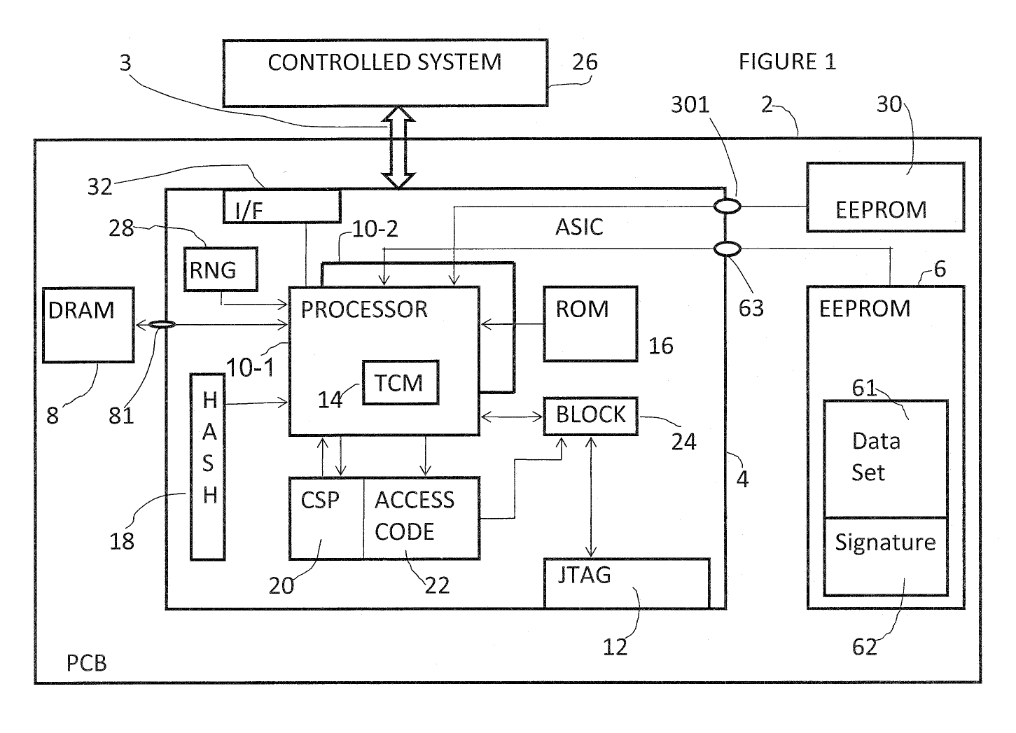

As shown in FIG. 1, the ASIC may have at least one interface 32 additional to the ports 3 and 12. That interface may be an Ethernet port or a fibre channel port.

The microcontroller may additionally have the further non-volatile store 30 outside the ASIC storing data cryptographically protected by a security parameter stored in the OTP memory 20. The further non-volatile memory 30 is coupled to the ASIC via the interface 301.

The further non-volatile store 30 may be an EEPROM. The further store 30 may store further critical security parameters outside the ASIC. The further parameters are encrypted and have digital signatures to make them secure. The further parameters are encrypted using the secret key, unique to the ASIC, stored in the OTP memory 20. The digital signatures of the further parameters are produced using the unique secret key stored in the OTP memory 20. That secret key is used to decrypt the further security parameters and to check the digital signatures read from the further store 30.

The further non-volatile store may contain other encrypted and/or digitally signed data.

The further security parameters outside the ASIC can be used to make secure data and code communicated via the interface(s) 32.

### Manufacture of the Microcontroller.

During manufacture, the boot code is hard coded into the boot ROM 16; the loader program and other code/data is stored in the EEPROM with digital signatures based on the public and private keys; and at least one public key is stored in the OTP memory 20.

The secret key is not stored in the OTP 20 until after the security code is set in the OTP 22 disabling the test port. The ASIC contains a random number generator RNG 28. Firmware stored in the tightly coupled memory 14 or the DRAM 8 reads a random number of for example 256 bits from the random number generator and stores it in the OTP 20 as the secret key without leaving the ASIC. This is done after the test port is disabled to prevent access to the secret key even by those having access to the manufacturing process.

The hash function may be any suitable hash function and is not limited to the example of HMAC as described above.

The on-chip random number generator 28 could be omitted from the integrated circuit and an off chip generator used instead to generate the secret key during the manufacturing process. However a random number generator on the chip is more secure.

The firmware stored in the EEPROM 6 is cryptographically protected, in this example, by digital signatures. During manufacture firstly, the firmware is compiled. It is then digitally signed using a secret private key of a private-public key system. The public key is stored in the OTP memory 20 to allow the signature to be validated. The signed firmware is stored in the EEPROM 6. The digital signatures may be created by submitting the compiled firmware to a secure signature generator during the manufacturing process. The signed firmware may be down loaded to the EEPROM 6 via a communications link e.g. the Internet.

Instead of an EEPROM, the non-volatile store 6 may be any other suitable device for example a FLASH memory.

The further non-volatile store 30 may be a serial EEPROM.

The one-time programmable memory OTP 22 containing the security code may be replaced by a reprogrammable non-volatile memory and the security code changed using signed firmware. A one-time programmable memory 22 is more secure since its programming is irreversible.

The DRAM may be further protected by physically making access to the DRAM very difficult and detectable if tried. For example the connections between the DRAM and the ASIC may be buried in layers of the PCB 2 or otherwise protected against physical probing.

The whole microcontroller may be enclosed in a tamper proof housing having tamper evident seals.

Although the invention has been described by way of example with reference to an ASIC, it is not limited to an ASIC. The invention may be applied to other types of integrated circuit data processors

The embodiments of the invention store data outside the integrated circuit. The embodiments of the invention ensure the data, including executable code, being processed cannot be changed by unauthorised people accessing the data stored outside the integrated circuit or if it is so accessed ensuring it cannot be changed undetectably. Security is provided by security data and the security data is itself secure because it is stored within the integrated circuit and protected from unauthorised access.

1. An apparatus comprising:
an integrated circuit containing a data processor and a non-volatile store storing at least one security code;
a first memory external to the integrated circuit storing data, the data being cryptographically protected in a first format; and
a second memory external to the integrated circuit for storing data;
the apparatus being arranged to transfer data from the first memory via the integrated circuit to the second memory to be accessed by the data processor from the second memory;
the integrated circuit being arranged to
validate during the transfer the data read from the first memory using a security code stored in the non-volatile store and, if the data is validated,
apply cryptographic protection in a second format to the validated data using a security code stored in the non-volatile store, and
store in the second memory the data protected in the second format.

2. Apparatus according to claim 1, wherein the first memory is a read only memory and the second memory is a random access memory.

3. Apparatus according to claim 1, wherein the cryptographic protection applied to data in the first memory is different from the cryptographic protection applied to the data in the second memory.

4. Apparatus according to claim 1, wherein the integrated circuit contains a store for storing data to be processed by the data processor,
the apparatus being arranged to store some data of the said validated data set in the store and store the remainder in the second memory.

5. Apparatus according to claim 1, wherein the first memory stores data in a first data format and the second memory is arranged to store data in a second, different, data format.

6. Apparatus according to claim 5, wherein the data stored in the first memory is protected by a first authentication technique and the apparatus is arranged to protect data in the second memory using a second different authentication technique.

7. Apparatus according to claim 1, wherein the data is stored in the first memory in at least one data set and the or each data set is cryptographically protected as a set and the apparatus is arranged to store in the second memory words or groups of words of a validated data set, each word or group of words being separately cryptographically protected.

8. Apparatus according to claim 7, arranged to read the words or groups of words from the second store, validate them using a security code stored in the non-volatile store, and process the read and validated words in the data processor.

9. Apparatus according to claim 8, wherein the integrated circuit has a hash calculator, the data processor and hash calculator being arranged to
a) calculate for each said word or group of words a hash function dependent on a security code stored in the said non-volatile store and store the hash in association with the word or group in the second memory,
b) retrieve from the second memory a stored word or group, recalculate a hash function for the retrieved word or group using the security code, and compare the recalculated hash with the stored hash, and
c) allow the retrieved word or group to be processed by the data processor only if the recalculated and stored hashes have a predetermined relationship.

10. Apparatus according to claim 9, wherein the hash calculator is a circuit in the integrated circuit.

11. Apparatus according to claim 1, wherein the non-volatile store of the integrated circuit is a one-time programmable memory.

12. Apparatus according to claim 1, wherein the or each data set stored in the first memory is cryptographically protected by a respective digital signature.

13. Apparatus according to claim 12, wherein the apparatus is arranged to validate a digital signature of a said data set by reference to a security code stored in the said non-volatile store of the integrated circuit.

14. A data processing apparatus comprising:
an integrated circuit having a data processor, a non-volatile store storing at least one security code, a hash calculator and an interface at the boundary of the integrated circuit; and
a memory external to the integrated circuit for storing data for use by the processor;
the memory being coupled to the data processor via the interface at the boundary of the integrated circuit to receive words from the data processor and to provide words to the data processor,
the data processor and hash calculator being arranged to
a) calculate for each word a hash function dependent on a security code stored in the said non-volatile store and store the hash in association with the word,
b) retrieve from the memory stored words, recalculate a hash function for each retrieved word using the security code, and compare the recalculated hash with the stored hash, and
c) allow the retrieved word to be processed by the data processor only if the recalculated and stored hashes have a predetermined relationship.

15. An apparatus comprising:
an integrated circuit containing a data processing means and a non-volatile storage means storing at least one security code;
a first means external to the integrated circuit storing data, the data being cryptographically protected in a first format at least by an authentication code; and
a second means external to the integrated circuit for storing data;
the apparatus comprising
means for transferring data from the first memory via the integrated circuit to the second memory to be accessed by the data processor from the second memory;
means for validating, during the transfer, the data read from the first memory using a security code stored in the non-volatile store and,
means for applying cryptographic protection comprising at least by an authentication code to the validated data in a second format using a security code stored in the non-volatile store if the data is validated, and
means for storing in the second memory the protected data in the second format.
